(19) United States
(12) Patent Application Publication
(10) Pub. No.: US 2003/0220713 A1
(43) Pub. Date: Nov. 27, 2003

(54) Vending system

(76) Inventor: Daniel Lawrence Owens, Berkshire (GB)

Correspondence Address: FISH & RICHARDSON P.C., 45 ROCKEFELLER PLAZA, SUITE 2800, NEW YORK, NY, 10111, US

(21) Appl. No.: 10/444,533

(22) Filed: May 23, 2003

(30) Foreign Application Priority Data
May 27, 2002 (EP) 02253711.2

(51) Int. Cl. G06F 17/00

(52) U.S. Cl. 700/236; 700/244

(57) ABSTRACT

A vending system which includes a number of vending machines and a central audit unit. The audit unit receives information pertaining to the operation of the vending machines and uses this information to model the operation of each machine over time. The model is then used to identify abnormal deviations in states of the vending machines such as a change in the ingredient consumption per dispensed product.

This invention relates to vending systems which include a plurality of vending machines under centralised monitoring. In general, such monitoring is exercised by an operator and includes determining optimal times to replenish the vending machines, route planning for the delivery persons who perform the replenishment, and reporting the activities of the system for accounting and further management purposes.

In particular, this invention shall be described in relation to vending machines which store ingredients in bulk and dispense these ingredients according to a recipe. It is to be realised however that the invention also finds application in relation to other vending machines.

Vending machines of the aforementioned type include control means which determine the amount of ingredients to be dispensed with reference to a stored recipe. It is also known for such control means to store information such as a running inventory of the ingredients stored in the machine, the payments received, change given and when the inventory is replenished.

It is known to collate such information and use it to keep track of the overall inventory and to assist in route planning for a person who replenishes the machines. It is also known to use this data for accounting and reporting purposes.

As the machines vend products the ingredients of which are stored in bulk and dispensed on demand, the amount of ingredients dispensed with each vending operation can vary. It is therefore difficult for an operator to keep track of inventory for each machine and to detect pilfering.

Aspects of the invention are set out in the accompanying claims.

According to a further independent aspect of the invention an audit unit models a vending machine according to data pertaining to states of the vending machine and compares data received from the vending machine against the model to detect deviations in the states.

Preferably the model includes a model of the vending machine recipe which is changed by the audit unit in dependence on the data.

The states may be fixed or may be variable. Fixed states may include states which do not alter or alter rarely and may, for example, include a serial number or other data identifying the vending machine, the position or location of the machine, identity of the person assigned to replenish the machine, part serial numbers, installation date and upcoming service dates.

Variable states include data pertaining to aspects which change more frequently and may, for example, include a snapshot of the inventory of the machine, the number of vends the machine has performed in a given time period, the amount of each ingredient used in the replenishment of the machine, whether the machine is operational and various diagnostic information.

The audit unit may model the vending machine on a statistical basis whereby historical performance of the machine is used as a basis to identify abnormal deviations in states of the machine. Alternatively, the model may be based on parameters which are externally determined and input into the audit unit.

Preferably, the model is used to predict fluctuations in the amount of ingredient the machine dispenses.

This has the advantage that the operation of each vending machine can be monitored from a central place and compared to its historical operation.

Although this invention is described in relation to vending machines which store ingredients in bulk, it is to be realised that the invention also finds application with respect to vending systems which incorporate other types of vending machines. For example, the invention can also be used to track stock for vending machines which do not mix ingredients but store and dispense individual items.

An arrangement embodying the invention will now be described by way of example with reference to the accompanying drawings in which:

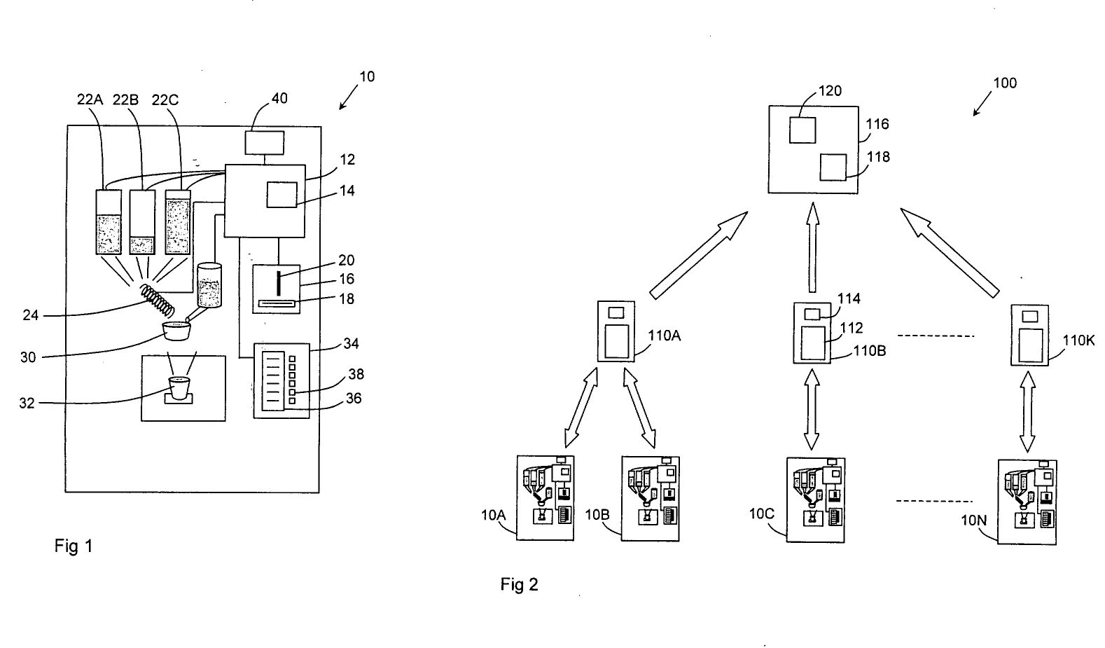

FIG. 1 is a schematic diagram of a vending machine in accordance with the invention; and

FIG. 2 is a schematic diagram of a vending system in accordance with the invention.

Referring to FIG. 1, a vending machine 10 comprises a vending machine control system (VMC) 12 which includes a memory 14. The VMC is connected to a currency acceptor 16. In the embodiment illustrated, the currency acceptor 16 is adapted to accept bills by means of a bill acceptor 18 or coins by means of a coin acceptor 20. Such currency acceptors are well known in the art and will therefore not be further described herein.

The VMC 12 is also connected to a plurality of hoppers some of which are shown at 22A, 22B, 22C which store ingredients in bulk. In this embodiment the vending machine 10 is adapted to dispense coffee, tea or hot chocolate. The hoppers 22A, 22B, 22C etc. therefore store granulated coffee, sugar, hot chocolate, tea and whitener.

An augur 24 controls dispensing of the ingredients stored in the hoppers 22A, 22B, 22C etc. The augur 24 is connected to the VMC 12 and is controlled thereby.

A hot water reservoir 28 is arranged to dispense hot water to a mixing bowl 30 and is connected to and controlled by the VMC 12.

The mixing bowl 30 receives the ingredients dispensed by the augur 24 and hot water dispensed from the hot water reservoir 32. A cup 32 receives the product mixed in the mixing bowl 30.

The vending machine also includes input means 34 which a user uses to select the desired product. The input means 34 includes a menu 36 and selection means 38.

A audit data collector 40 is connected to the VMC 12 whereby data stored in the memory 14 of the VMC 12 may be transferred to an external source as described below.

The operation of the vending machine 10 shall now be described with reference to FIG. 1.

A user enters appropriate payment into the payment acceptor 16 and selects a product from the menu 36 by operating the selection means 38. The payment acceptor 16 verifies the authenticity of the payment. Once payment is accepted, this is communicated to the VMC 12 which operates the augur 24 to dispense the requisite amount of the stored ingredients from the hoppers 22A, 22B, 22C etc. to the mixing bowl 30 in accordance with a recipe stored in the memory 14 for the selected product. The VMC also operates the hot water reservoir 28 so that hot water is delivered to the mixing bowl 30. The ingredients and the hot water are mixed in the mixing bowl 30 and the resultant product is transferred to the cup 32 which is picked up by the user.

The VMC delivers the ingredients to the mixing bowl by rotating the augur through a predetermined number of revolutions corresponding to the amount of the ingredient required by the appropriate recipe. It is to be appreciated however that the amount of the item delivered by the augur will not be constant for each dispensing instance due to, among others, random fluctuations caused by machine part tolerances and wear and tear of the parts. It is therefore difficult to predict accurately the amounts which the vending machine will dispense as a function of the number of vends performed.

The memory 14 of the VMC also stores information pertaining to various states of the vending machine 10. In the embodiment shown this stores a record of the number of vends of each particular product since the last replenishment of the hoppers 22A, 22B, 22C etc. and the amount of money retained by the payment acceptor 16.

FIG. 2 illustrates a vending system 100. Like numerals shall be used to designate like elements illustrated in FIG. 1. The vending system 100 includes a plurality of vending machines 10A, 10B, 10C . . . 10N each as illustrated in FIG. 1. Each vending machine 10A, 10B, 10C, . . . 10N stores data in the memory of the corresponding VMC of the machine based on various states of that machine over time.

As the vending machines dispense products, the ingredients stored in the hoppers 22A, 22B, 22C require replenishing. This is performed manually whereby deliveries of ingredients to each vending machine are carried out by a delivery person. This delivery person will replenish the hoppers and make a record of the amount remaining in the hoppers which are replenished. To capture this information each delivery person is equipped with a portable computing device 110A, 110B, . . . 110K each of which includes corresponding input means 112 and memory 114. In the embodiment shown, the portable computing devices 110A, 110B, . . . 110K are palm-top computers.

When the delivery person replenishes the inventory for a particular vending machine, the corresponding portable computing device is used to make a record of the identity of the vending machine and the amount of each type of ingredient remaining in the hoppers which are replenished.

The portable computing device 110A, 110B, . . . 110K is connected to the audit data collector 40 of the vending machine and the data stored in the vending machine is transferred to the memory 114 of the device. Data pertinent to the configuration of the audit data collector 40 also flows from the portable computing device 110A, 110B, . . . 110K to the audit data collector 40.

Once the delivery person has completed replenishment of the vending machines to which he has been assigned, the portable computing device is connected to an audit unit 116. The audit unit 116 is a computer which includes a processor 118 and memory 120.

Data is transferred from the portable computing devices 110A, 110B, . . . 110K to the memory 120 of the audit unit 116 while they are connected. The audit unit 116 then uses software to model each vending machine 10A, 110B, 110C, . . . 110N on the basis of the data received.

By collating data representing the time period between replenishment of the hoppers, the amount of ingredient remaining in each hopper and the number of products dispensed and comparing this against the recipes for each product, the audit unit can model the operation of the vending machine.

For example, with reference to vending machine 10A, a delivery person will make a record of the amount of each ingredient with which the hoppers of the machine are replenished, the identity of the machine and the date and time when the machine was replenished. This information is transferred to the audit unit 116 by the portable computing device 110A in the manner described above. This process is repeated every time the vending machine 10A is replenished.

The audit unit 116 builds a model of vending machine 10A using the data obtained in this way. The model includes a recipe which reflects the amount of each ingredient which the vending machine 10A dispenses for each particular product. The modelled recipe therefore changes over time as each set of data collected by the delivery person is incorporated into the model.

The audit unit will set a range of values for ingredient use for each vending machine which are deemed acceptable relative to the data received. These values are based on a statistical analysis of the amounts of each ingredient the particular vending machine has used in the past.

The audit unit calculates actual ingredient use per dispensed item from each set of data. This is then compared to the modelled recipe and the user is notified when that discrepancy falls outside the accepted range of values.

The audit unit 116 therefore has the ability to detect abnormal states in a vending machine 10 and where this occurs to generate a message to inform a user. The user can then utilise this information to investigate the matter further. If, for example, the detected discrepancy is due to a malfunction of the vending machine a repairman can be allocated to fix the malfunction. Alternatively, if the discrepancy is due to pilfering on the part of the delivery person, appropriate steps can be taken to prevent this reoccurring.

As the audit unit 116 also maintains information pertaining to the route and the particular vending machines which each particular delivery person is responsible for, a delivery person who consistently pilfers from different vending machines on a particular route can be detected. The software of the audit unit 116 compares fluctuations in the models of all the vending machines on the route for a particular delivery person and notifies a user if a pattern of deviations of the states of the machines on that route is detected.

The audit unit 116 is also configured to compare the number of products a vending machine 10 has dispensed to the amount of money which that machine has collected. If a discrepancy arises from this comparison, the user is notified and appropriate steps (as described above) can be taken to address this.

The modelled recipes can also be used as to alter the recipes stored in the memories 14 of the VMC 12 of the vending machines 10A, 10B, 10C, . . . 10N to minimise the discrepancy between this recipe and the modelled recipe.

Although in the embodiment shown, the delivery person and the portable computing device 110A, 110B, . . . 110C act as a conduit for the information between the audit unit 116 and the vending machines 10A, 10B, 10C, . . . 10N, it is to be realised that any appropriate means of doing so could be utilised and this may, for example, include automatic means such as a network connection between the audit unit 116 and the VMC 12.

1. A vending system comprising a plurality of vending machines, an audit unit and means for transferring data indicative of states of each vending machine at least from each vending machine to the audit unit in which the audit unit models each vending machine according to the data and compares the data against the model to detect deviations in the states.

2. The vending system of claim 1 wherein the transfer means is a portable computing device.

3. The vending system of claim 1 or 2 wherein the audit unit is a computer.

4. The vending system of claim 3 wherein the modelling process occurs in software.

5. The vending system of claims 1 to 4 wherein the data is at least indicative of an amount of ingredient dispensed in a predetermined period.

6. The vending system of claims 1 to 5 wherein the data is indicative of a type of ingredient dispensed.

7. The vending system of claim 5 or 6 wherein the predetermined period is the period between replenishments of the ingredients.

8. The vending system of any preceding claim wherein the model includes a recipe corresponding to each vending machine and the recipe is updated dependent on the data.

9. The vending system of claim 1 wherein the transfer means is a network connection.

10. The vending machine of claim 9 wherein the network connection includes an infrared connection.

11. An audit unit for use with a vending system as claimed in any preceding claim.

12. A vending machine for use with a vending system as claimed in any preceding claim.

13. A method of operating a vending system having a plurality of vending machines, an audit unit and means for transferring data at least between each vending machine and the audit unit which includes the steps of:
a. collating data at each vending machine indicative of states of the vending machine,
b. using the transfer means to transfer the data from each vending machine to the audit unit,
c. producing a model of each vending machine based on the data, and
d. using the model to identify deviations in the states of the vending machines.
